(19) United States
(12) Patent Application Publication
(10) Pub. No.: US 2009/0178526 A1
(43) Pub. Date: Jul. 16, 2009

(54) MOBILE COLLECTING DEVICE FOR THE HIGH-PRESSURE WATER JET OF A WATER-JET TOOL AND METHOD OF USE

(76) Inventors: Philipp Roth, Baden (CH); Josef Erni, Winterthur (CH); Walter Maurer, Oftringen (CH)

Correspondence Address: CERMAK KENEALY VAIDYA & NAKAJIMA LLP, 515 E. BRADDOCK RD, ALEXANDRIA, VA, 22314, US

(21) Appl. No.: 12/349,121

(22) Filed: Jan. 6, 2009

(30) Foreign Application Priority Data
Jan. 10, 2008 (CH) 00036/08

(51) Int. Cl. B26D 5/00

(52) U.S. Cl. 83/72; 137/312

(57) ABSTRACT

A mobile collecting device (22) for the high-pressure water jet (26) of a water-jet tool (18), especially for working in confined places with difficult access in turbines or the like, in which a more flexible and safer operation is achieved by a closed collecting chamber (24), which extends over a large area and includes an outlet (30), and in which a rigid first collecting bed (34) formed of a first high-pressure-resistant material is arranged.

This application claims priority under 35 U.S.C. §119 to Swiss application no. 00036/08, filed 10 Jan. 2008, the entirety of which is incorporated by reference herein.

### BACKGROUND

1. Field of Endeavor

The present invention refers to the field of machining of workpieces by material stripping. It relates to a mobile collecting device for the high-pressure water jet of a water jet tool and also to a method for its operation.

2. Brief Description of the Related Art

It has been known for a long time to use a water jet, which issues under very high pressure from a nozzle, for the machining, especially the cutting, of workpieces. In the case of so-called “abrasive water-jet cutting” (AWJ), water pressures of more than 300 MPa are used in order to produce a water jet, which is laden with abrasive substances, with a jet diameter of typically 1 mm. Such a water jet can be used as a cutting tool which acts in all directions and with which a wide range of metallic and non-metallic materials, with thicknesses of up to 200 mm, can be cut through. In this case, it is important not to only collect and drain off the water of the high-pressure water jet, but especially to render the kinetic energy of the water jet harmless by conversion into thermal energy if this water jet has worked its way through the workpiece and discharged rearwards (downwards) from the workpiece.

In the case of stationary systems, in which the nozzle head of the water-jet tool is movable in a plane in X and Y directions, the mostly plate-form workpiece is fixed on a largely jet-penetrable support base. Beneath the support base, special devices are then arranged over a large area for collecting and rendering harmless the high-pressure water jet which passes through the workpiece (see for example U.S. Pat. Nos. 4,112,797 and 5,295,425).

Compact collecting devices have already been proposed, however, which can be moved together with the water-jet tool and can also be used in the case of confined space conditions at the application site (see for example EP-A2-0 244 966 and EP-A2-0 252 657). In this case, however, it is disadvantageous that the entry areas which are provided for the water jet are very small so that the collecting devices have to be adjusted very accurately to the water-jet tool.

In a prior application of the assignee of this application, it was proposed to use a water-jet tool with turbine rotors and other components of power plants. With the turbine rotors fitted with rotor blades, according to FIGS. 1 and 2, it is a matter of separating the blades 12, which are detachably fastened on the turbine wheels 11 of the rotor 10, from the rotor 10 by cutting up the bolts 17, which are interference-fitted in corresponding holes 16 and connect the blade roots 14, which are beneath the blade platform 13 and recessed in annular grooves 15, to the turbine wheel 11, by a water-jet tool 18 in the longitudinal direction, and then forcing out the bolt sections from the holes 16. The water-jet tool 18, which includes a tool body 19 and an angled nozzle head 20 and is supplied with water via a water feed line 21, is introduced into the interspace between adjacent turbine wheels 11 and 11′ (FIG. 2) for this purpose. If the bolt 17 is cut through in the longitudinal direction, the high-pressure water jet discharges on the other side of the turbine disk 11 into the interspace which exists there and can cause damage if it is not collected and rendered harmless.

### SUMMARY

One of numerous aspects of the present invention includes a collecting device for the high-pressure water jet of a water-jet tool which, even in inaccessible places and in the case of confined space conditions, can be used in different spatial positions in order to safely collect the water jet which passes through the workpiece during workpiece machining, and also a method for its operation.

According to another aspect, a closed collecting chamber, which extends over a large area and is provided with an outlet, and in which a rigid first collecting bed having a first high-pressure-resistant material is arranged, is advantageously provided for the device.

One exemplary development includes that the first collecting bed includes a plurality of layers, having the first high-pressure-resistant material, which are arranged one above the other, each of the layers is constructed from bars, formed of the first high-pressure-resistant material, which lie parallel in one plane next to each other, and the bars of consecutive layers are oriented orthogonally to each other.

Another exemplary development includes that a hard material is used as the first high-pressure-resistant material, wherein tungsten carbide (WC) is preferably used as the hard material.

A further exemplary development includes that the first collecting bed fills out the lower part of the collecting chamber, the upper part of the collecting chamber is filled with a filling material, and waste or fragmented material of the first high-pressure-resistant material is used as the filling material.

Another exemplary development includes that the collecting chamber is accommodated in a cubic housing and on the upper side which faces the high-pressure water jet is closed off by a cover of the housing.

According to a preferred exemplary development, a safety chamber is arranged after the collecting chamber in the direction of the high-pressure water jet, wherein in the safety chamber, a rigid second collecting bed formed of a second high-pressure-resistant material is arranged, the second collecting bed includes a plurality of layers, formed of the second high-pressure-resistant material, which are arranged one above the other, each of the layers is constructed from bars, formed of the second high-pressure-resistant material, which lie parallel in one plane next to each other, the bars of consecutive layers are oriented orthogonally to each other, and wherein the second high-pressure-resistant material is identical to the first high-pressure-resistant material.

Another exemplary development includes that the collecting chamber and the safety chamber are separated from each other by a partition, the safety chamber has openings, and a moisture sensor is associated with the openings and detects water which discharges from the opening of the safety chamber.

Furthermore, it is advantageous if an acceleration sensor is arranged on the collecting device for detecting penetration of the high-pressure water jet through a workpiece which is to be machined and located upstream of the collecting device.

In particular, the sensors are connected to a signal processing device which, at a signal output, generates a signal for controlling the water-jet tool.

Exemplary methods according to principles of the present invention include that the first impact of the high-pressure water jet upon the collecting device is detected in each case, and a corresponding signal is used for controlling the use of the water-jet tool, or a malfunction of the collecting device is detected and a corresponding signal is used for terminating the use of the water-jet tool.

### BRIEF DESCRIPTION OF THE DRAWINGS

The invention is to be explained in more detail in the following based on exemplary embodiments in conjunction with the drawing. In the drawing

FIG. 1 shows in a perspective view a detail of a rotor with blades which are fastened on the rotor by means of bolts;

FIG. 2 shows, in a view which is comparable to FIG. 1, a method for removing the fastening bolts of the rotor blades by a high-pressure water jet;

FIG. 3 shows a mobile collecting device for a high-pressure water jet according to FIG. 2 according to an exemplary embodiment of the invention; and

FIG. 4 shows the internal construction of the collecting device from FIG. 3.

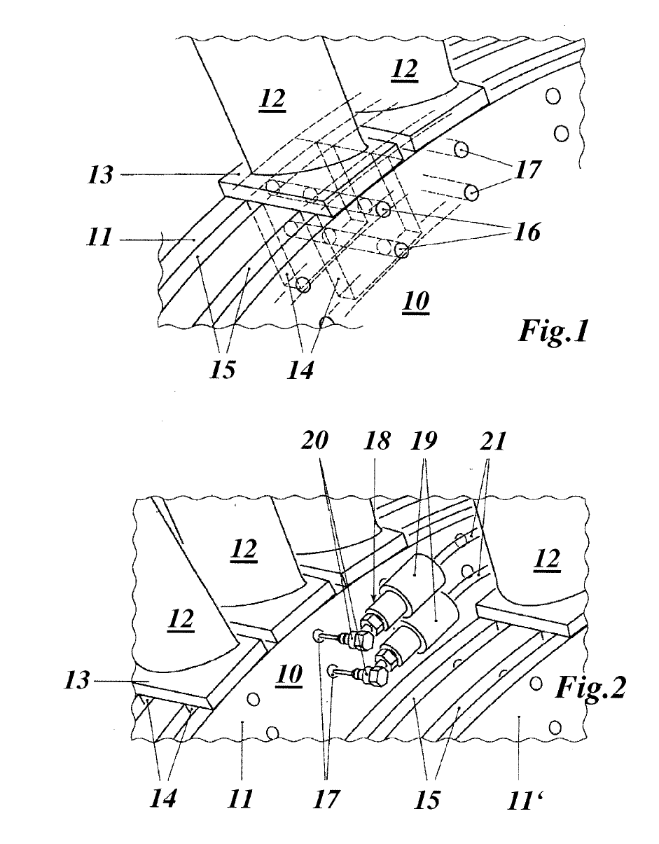

### DETAILED DESCRIPTION OF EXEMPLARY EMBODIMENTS

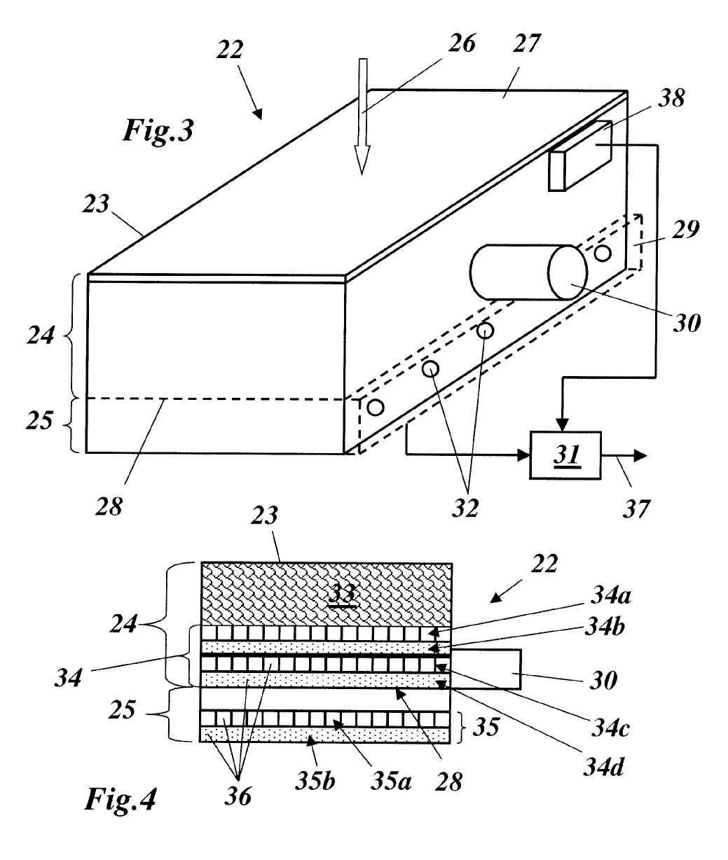

In FIG. 3, a mobile collecting device for a high-pressure water jet according to an exemplary embodiment of the invention is reproduced. This collecting device 22 is particularly suitable for applications when machining turbine rotors (FIG. 2) and components of power plants, in which the space which is made available is limited. The external dimensions of the exemplary collecting device 22 are approximately 200 mm×80 mm×80 mm so that it can be used in the narrow interspaces between adjacent turbine wheels (11, 11′ in FIG. 2) or rotor disks.

The collecting device 22 of FIG. 3 has a cubic housing 23 which is closed off at the top by a cover 27. The interior space of the housing 23 or of the collecting device 22 is divided by a partition 28, which lies parallel to the cover 27, into two chambers, specifically the (upper) collecting chamber 24, in which the residual kinetic energy of the abrasive high-pressure water jet 26 is absorbed and converted into thermal energy, and the (lower) safety chamber 25, by which it can be established when the device fails in its normal service so that the machining process can be aborted in sufficient time. The internal structure of the collecting device 22 is reproduced in FIG. 4 in side view.

The collecting chamber 24 is filled at the bottom, i.e., directly above the partition 28, with a first collecting bed 34 formed of at least four layers 34a-d of bars 36, advantageously made of tungsten carbide (WC), which lie one above the other. The bars 36 of the same layer in this case are oriented parallel to each other, but perpendicularly to the bars of the adjacent layers so that a crosswise alternating lamination results. Above the layers 34a-d, the collecting chamber 24 is filled with loose filling material 33 which includes or consists of WC waste or fragmented material (for example, used WC reversible tips). The filling material 33 serves for breaking down the coherence of the high-pressure water jet which enters the chamber. At the bottom of the collecting chamber 24, an outlet 30 is attached, by which the material (water and solid particles) which enters the collecting chamber can be sucked out by a suction device in order to keep the application area clean.

The safety chamber 25, which lies beneath the partition 28, at the bottom is filled with a second collecting bed 35 formed of at least two layers 35a, b of bars 36 made of tungsten carbide, which are again arranged in a crosswise manner. A plurality of openings of small diameter, which serve as outlets and to which a moisture sensor 29 (drawn in with a dashed line in FIG. 3) is allocated, are provided on one side of the safety chamber 25. The moisture sensor 29 is activated if the high-pressure water jet 26 breaks through the collecting chamber 24 into the safety chamber 25 which lies beneath it so that the machining process can be stopped in sufficient time. The two layers 35a, b contain the jet in the process until the moisture sensor 29 has been safely activated.

An acceleration sensor 38 can be advantageously attached on the outer side of the collecting device 22 and is activated if the high-pressure water jet 26 passes for the first time through the workpiece, which is to be machined, onto the collecting device 22.

Both the acceleration sensor 38 and the moisture sensor 29 can be used for controlling or checking the machining process. For this purpose, the sensors are connected to a signal processing device 31 which at a signal output 37 delivers corresponding control signals to the control unit (not shown in the figures) of the machining processes. The collecting device thus becomes part of the control system of the water-jet tool. If the moisture sensor 29 is activated, the machining process is aborted. If the acceleration sensor 28 is activated, for example the next machining step is initiated.

The collecting device 22 is simply and inexpensively constructed and represents an easily exchangeable wear-resistant component. It can be installed in an exchangeable manner in an application-specific holder.

List of designations

10 Rotor (turbine)

11, 11′ Turbine wheel

12 Blade

13 Blade platform

14 Blade root

15 Annular groove (turbine wheel)

16 Hole

17 Bolt

18 Water-jet tool

19 Tool body

20 Nozzle head

21 Water feed line

22 Collecting device

23 Housing

24 Collecting chamber

25 Safety chamber

26 High-pressure water jet

27 Cover

28 Partition

29 Moisture sensor

30 Outlet (collecting chamber)

31 Signal processing device

32 Opening (safety chamber)

33 Filling material (for example WC waste)

34 Collecting bed

34a-d Layer (for example WC bars)

35 Collecting bed

35a, b Layer (for example WC bars)

36 Bar

37 Signal output

38 Acceleration sensor

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A mobile collecting device for the high-pressure water jet of a water-jet tool, the device comprising:
a closed collecting chamber extending over a large area and including an outlet; and
a rigid first collecting bed in the chamber, the bed comprising a first high-pressure-resistant material.

2. The collecting device as claimed in claim 1, wherein the first collecting bed comprises a plurality of layers, each formed of the first high-pressure-resistant material, arranged one above the other.

3. The collecting device as claimed in claim 2, wherein each of the plurality of layers comprises bars formed of the first high-pressure-resistant material, the bars extending parallel in one plane next to each other.

4. The collecting device as claimed in claim 3, wherein the bars of consecutive layers are oriented orthogonally to each other.

5. The collecting device as claimed in claim 1, wherein a hard substance is used as the first high-pressure-resistant material.

6. The collecting device as claimed in claim 5, wherein the hard substance is tungsten carbide.

7. The collecting device as claimed in claim 1, wherein the collecting chamber comprises lower and upper parts, wherein the first collecting bed fills out the lower part of the collecting chamber, and further comprising a filling material filling the upper part of the collecting chamber.

8. The collecting device as claimed in claim 7, wherein the filling material comprises waste or fragmented material of the first high-pressure-resistant material.

9. The collecting device as claimed in claim 1, further comprising:
a cubic housing having an upper side and a cover at said upper side, the collecting chamber positioned in the cubic housing, and the upper side being closed off by the cover.

10. The collecting device as claimed in claim 1, further comprising:
a safety chamber arranged after the collecting chamber in the direction of the high-pressure water jet.

11. The collecting device as claimed in claim 10, further comprising:
a rigid second collecting bed, formed of a second high-pressure-resistant material, arranged in the safety chamber.

12. The collecting device as claimed in claim 11, wherein the second collecting bed comprises a plurality of layers, wherein each layer is formed of the second high-pressure-resistant material, and wherein the plurality of layers of the second collecting bed are arranged one above the other.

13. The collecting device as claimed in claim 12, wherein each of the plurality of layers of the second collecting bed comprises bars, each bar is formed of the second high-pressure-resistant material, and wherein the bars extend parallel in one plane next to each other.

14. The collecting device as claimed in claim 13, wherein the bars of consecutive layers are oriented orthogonally to each other.

15. The collecting device as claimed in claim 11, wherein the second high-pressure-resistant material is identical to the first high-pressure-resistant material.

16. The collecting device as claimed in claim 10, further comprising a partition separating the collecting chamber and the safety chamber from each other, wherein the safety chamber comprises openings, and further comprising a moisture sensor associated with the openings configured and arranged to detect water which discharges from the opening of the safety chamber.

17. The collecting device as claimed in claim 1, further comprising an acceleration sensor arranged on the collecting device configured and arranged to detect penetration of the high-pressure water jet through a workpiece which is to be machined and located upstream of the collecting device.

18. The collecting device as claimed in claim 16, further comprising a signal processing device having a signal output useful for controlling the water-jet tool, the sensor connected to the signal processing device.

19. A method for operating a collecting device, the method comprising:
providing a collecting device as claimed in claim 1;
detecting a first impact of the high-pressure water jet upon the collecting device; and
controlling the use of the water-jet tool based on a signal derived from said detecting.

20. A method for operating a collecting device, the method comprising:
providing a collecting device as claimed in claim 1;
detecting a malfunction of the collecting device; and
terminating the use of the water-jet tool based on a signal derived from said detecting.
